(19) United States
(12) Patent Application Publication
(10) Pub. No.: US 2024/0393574 A1
(43) Pub. Date: Nov. 28, 2024

(54) OPTICAL MICROSCOPE COMPRISING AN OPTOMECHANICAL FINE-ADJUSTMENT DEVICE AND OPTOMECHANICAL ADJUSTMENT METHOD

(71) Applicant: HORIBA FRANCE SAS, PALAISEAU (FR)

(72) Inventors: Vasily GAVRILYUK, PALAISEAU (FR); Alexander YAGOVKIN, LAMBERSART (FR)

(21) Appl. No.: 18/696,869

(22) PCT Filed: Sep. 27, 2022
(86) PCT No.: PCT/EP2022/076871

§ 371 Date: Mar. 28, 2024

(30) Foreign Application Priority Data
Sep. 29, 2021 (FR) 2110276

(51) Int. Cl. G02B 21/00; G02B 6/26; G02B 6/42

(52) U.S. Cl. CPC G02B 21/0072; G02B 6/262; G02B 6/4226; G02B 21/0076

(57) ABSTRACT

The invention relates to an optical microscope comprising an optical system (1) and a confocal diaphragm (2), the confocal diaphragm (2) being arranged in a Fourier plane (12) of the microscope, the confocal diaphragm (2) being fixed relative to the body of the microscope, the microscope being able to collect a light beam (20) from the object plane, the optical system (1) being suitable for focusing the light beam (20) in the Fourier plane (12) and for feeding at least a portion of the light beam (20) through the confocal diaphragm (2). According to the invention, the optical microscope comprises a refractive optical component (3) placed between the optical system (1) and the confocal diaphragm (2), the refractive optical component (3) being mounted so as to be rotatable transverse to the optical axis (10) of the microscope in order to adjust a lateral position of the focused light beam relative to the confocal diaphragm (2).

### TECHNICAL FIELD

The present invention relates to the technical field of optical microscopy.

More particularly, it relates to a device and a method for optomechanical adjustment of a collected light beam towards a detector in a confocal microscope.

Such a device finds in particular applications in spatial filtering of light beams or coupling to an optical fibre.

### PRIOR ART

A confocal microscope, and in particular a Raman confocal microscope, implements a spatial filtering of the radiation emitted by a sample and collected by a microscope objective. For that purpose, a confocal diaphragm is used, which comprises a confocal hole or an optical fibre having micrometric cross-sectional dimensions. The confocal diaphragm is generally arranged in the microscope tube, in a so-called Fourier plane, optically conjugate with an object plane via the microscope objective and a tube lens. An optical system transmits the spatially filtered signal towards a detection system, for example of the spectrometric type or for time-resolved measurements, depending on the requirements for acquiring the desired information. The spatial filtering enables to extract the optical signal coming from a point of interest of the sample and to separate it from the optical signals coming from other areas of the sample. In particular, in a Raman microscope, the spatial filtering makes it possible to extract the Raman signal emitted by a specific area of the sample.

However, the confocal diaphragm has generally micrometric cross-sectional dimensions. These dimensions are determined by the Point Spread Function, PSF, generated by scattering of the collected light beam on the microscope objective. These micrometric dimensions make it necessary to direct the collected beam with great precision towards the confocal diaphragm. The microscope must therefore be extremely stable and optomechanically rigid.

The confocal diaphragm is generally mounted inside the microscope body. The confocal diaphragm position, aligned to the microscope optical axis, is factory-set. The confocal diaphragm is generally not accessible to the user. This configuration enables the confocal diaphragm to be protected from external influences.

In a particular case, the microscope is connected by optical fibre to a detection system. The optical fibre end forms a confocal diaphragm whose dimensions are determined by the optical fibre aperture. The microscope optical system is generally adapted to focus the beam with an aperture of same value as the numerical aperture of the fibre. The microscope optical system is also corrected for the spherical aberration. To align the optical fibre end to the focused beam, it is known to use an optical fibre positioning mechanism. However, such a mechanism can pose difficulties, as a movement of the fibre, such as bending or twisting, can transmit a certain force to this mechanism and cause misalignment and signal loss.

It is desirable to have an adjustment system in a confocal optical microscope or in a confocal Raman microscope, connected in free space or by optical fibre to a detection system, to enable the optical alignment adjustment while insuring the stability of the assembly.

### SUMMARY OF THE INVENTION

In order to remedy the above-mentioned drawbacks of the state of the art, the present invention proposes an optical microscope comprising an optical system and a confocal diaphragm, the confocal diaphragm being arranged in a Fourier plane of the microscope, transverse to an optical axis of the microscope, the Fourier plane being optically conjugated with an object plane via the optical system, the confocal diaphragm being fixed relative to the microscope body, the microscope being able to collect a light beam from the object plane, the optical system being adapted to focus the light beam in the Fourier plane and to inject at least a portion of the light beam through the confocal diaphragm.

According to the invention, the optical microscope includes a refractive optical component arranged between the optical system and the confocal diaphragm, the refractive optical component being rotatably mounted transverse to the optical axis of the microscope, in order to adjust a lateral position of the focused light beam relative to the confocal diaphragm.

According to an embodiment, the confocal diaphragm comprises a confocal hole.

According to a particular aspect of this embodiment, the confocal diaphragm is formed by an end of an optical fibre having a core with micrometric cross-sectional dimensions.

Advantageously, the optical microscope comprises an optical fibre connector, the optical fibre connector being attached rigidly to the microscope body, the optical fibre connector being suitable for receiving the optical fibre end in such a way that the optical fibre end is arranged in a real image plane of the microscope.

According to a particular aspect, the optical system has an image numerical aperture of less than 0.1 or even than 0.05, and the refractive optical component comprises a transparent plate with flat and parallel faces, the plate being rotatably mounted about at least one axis of rotation transverse to the microscope optical axis.

According to a particular aspect, the plate is a glass plate, for example of the BK7 type, the plate having a thickness between 1 and 6 mm. Advantageously, at least one of the faces of the plate includes anti-reflective coating, for example made of thin layers.

According to another embodiment, the confocal diaphragm is formed by an optical fibre end having a determined numerical aperture NA, for example about 0.22, the optical system has an image numerical aperture adapted to that of the optical fibre and the refractive optical component comprises a converging lens, for example a plano-convex lens, rotatably mounted about a centre of rotation on the microscope optical axis between the lens and the focal plane. Advantageously, in this example, the optical system has an image numerical aperture higher than 0.1, for example of the order of 0.2.

According to a particular and advantageous aspect, the optical microscope comprises a laser source adapted to generate an excitation laser beam, the confocal diaphragm being arranged between the optical system and a detector adapted to detect a Raman scattering radiation.

Advantageously, the microscope comprises an opaque housing, the confocal diaphragm and the refractive optical component being arranged inside the housing, the refractive optical component being mounted on a translation and/or rotation stage, said stage including optomechanical adjustment means, the optomechanical adjustment means being accessible from the outside of the housing.

Advantageously, the optical system comprises a microscope objective and a tube lens. Advantageously, the microscope objective forms the image of the object at infinity and the Fourier plane is merged with the real image plane of the object downstream of the tube lens.

The invention also relates to an optical microscopy method comprising the steps of: collecting a light beam from an object plane and focusing the collected light beam in a Fourier plane by means of an optical system in a microscope, the Fourier plane of the tube lens coinciding with the real image plane of the object plane and being optically conjugate with the object plane, the Fourier plane being transverse to an optical axis of the microscope; transmitting the collected light beam through a refractive optical component arranged between the optical system and the Fourier plane; focusing the light beam transmitted on a confocal diaphragm arranged in the Fourier plane of the microscope, the confocal diaphragm being fixed with respect to the microscope body; adjusting the refractive optical component by rotation transverse to the microscope optical axis in order to adjust a lateral position of the focused light beam relative to the confocal diaphragm.

Advantageously, the optical system of the microscope comprises a microscope objective and a tube lens, the objective forming an image of the object plane at the infinite.

Obviously, the various features, alternatives and embodiments of the invention can be associated with each other according to various combinations, insofar as they are not incompatible or exclusive with respect to each other.

### BRIEF DESCRIPTION OF DRAWINGS

Moreover, various other features of the invention emerge from the appended description made with reference to the drawings that illustrate non-limiting embodiments of the invention, and wherein:

FIG. 1 is a schematic cross-sectional view of an embodiment of the invention,

FIG. 2 is a perspective view of another embodiment of the invention,

FIG. 3 is a schematic cross-sectional view of this other embodiment of the invention,

FIG. 4 is a diagram illustrating the displacement of the focal points for rays in the meridional plane perpendicular to the axis of rotation of a plano-convex lens, induced by the rotation of a refractive optical element of the lens type.

It is to be noted that, in these figures, the structural and/or functional elements common to the different alternatives can have the same references numbers.

### DETAILED DESCRIPTION OF THE INVENTION

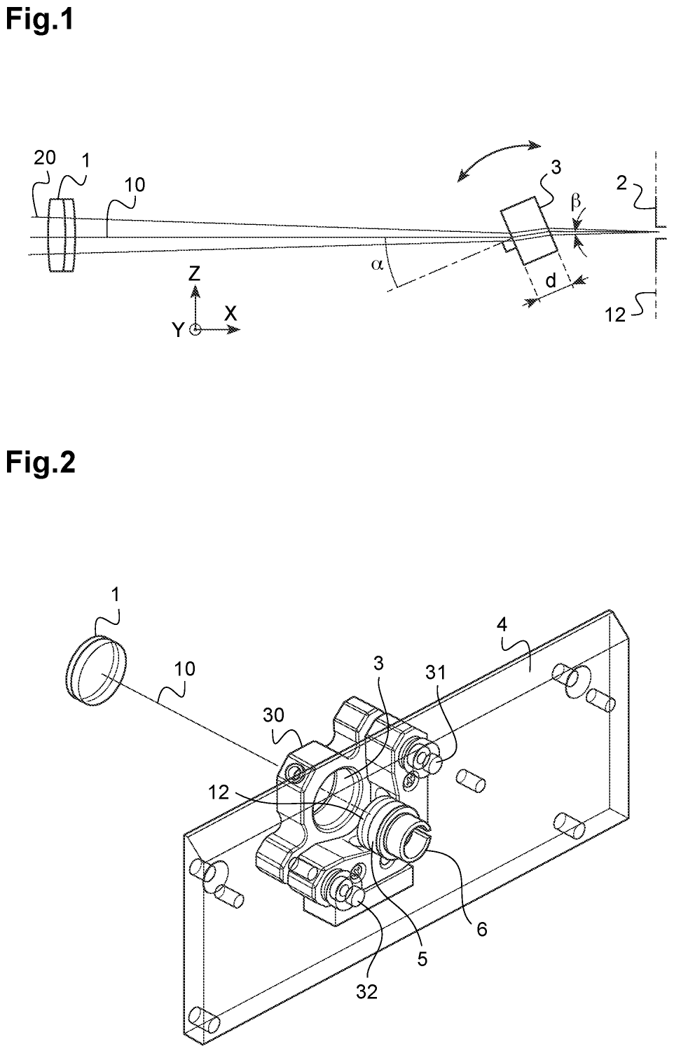

FIG. 1 shows a portion of an instrument, for example an optical microscope or a Raman microscope. Neither the microscope frame or body, nor the microscope objective, nor the detection system, are shown in this figure.

Generally, such a microscope includes a microscope objective, a tube and a tube lens. The microscope objective collects a light beam from an object plane of the microscope. The objective is generally corrected for the aberrations at the infinite and forms a collimated beam. The tube lens receives the collimated beam 20 and forms the image thereof in its focal plane, optically conjugate with the object plane of the microscope. In a confocal microscope, a confocal diaphragm is arranged in said focal plane to spatially filter the optical signal and to suppress the signals coming from other points than the point of interest in the object plane.

Only the microscope portion located between an optical system 1 and the real image plane 12 is shown in FIG. 1. The optical system 1 represents for example the tube lens of a confocal microscope. A confocal diaphragm 2 is arranged in the real image plane 12, which is merged with the focal plane of the optical system 1. The confocal diaphragm 2 includes a generally disc-shaped aperture. The aperture diameter is generally between 20 and 100 micrometres. By way of example, a confocal diaphragm 2 with a circular aperture of 30 to 50 micrometres in diameter is used.

An orthonormal reference frame is shown in FIG. 1. The optical axis 10 of the microscope is here parallel to axis Z.

According to the present disclosure, a refractive optical component 3 is arranged between the optical system 1 and the confocal diaphragm 2. By way of example in FIG. 1, the refractive optical component 3 is consisted of a plate with flat and parallel faces, of thickness d. The refractive optical component 3 is rotatably mounted about at least one axis transverse to the optical axis 10 of the microscope.

For example, the refractive optical component 3 is rotatably mounted about X-axis. The rotation of the refractive optical component 3 about X-axis enables to vary the position of the focused beam in the Fourier plane along Y-axis.

Similarly, the refractive optical component 3 is rotatably mounted about Y-axis. The rotation of the refractive optical component 3 about Y-axis enables to vary the position of the focused beam in the Fourier plane along X-axis.

Advantageously, the refractive optical component 3 is rotatably mounted about Y-axis and about X-axis, to enable the X and Y position of the focused beam in the Fourier plane 12 to be adjusted.

The lateral resolution of an optical microscope is determined by the wavelength of the light used and the numerical aperture of the microscope objective. The numerical aperture of an objective without immersion cannot exceed 1. The microscope optical system produces a real image of the sample in the plane of the confocal diaphragm 2. The microscope is considered here as an aplanatic optical system and the numerical aperture in the image space can be deduced from the Abbe sine condition. For a microscope having a lateral magnification of 50 (objective 100× and tube lens of focal length F=100 mm), the numerical aperture in the image space does not exceed 1/50=0.02. This relatively low numerical aperture means that all the rays forming the image are a little inclined relative to the optical axis. The insertion of a refractive optical component 3 of the glass plate type, of thickness d, in front of the image plane 12 does not significantly deteriorate the focusing quality. The angle of incidence of the marginal ray in the image space is denoted β. The angle β is here in the YZ-plane. With a numerical aperture of 0.02 in the image space, the angle of incidence β is of about 0.02 rad. An estimate of the spherical aberration produced by a glass plate with flat and parallel faces, of refractive index n=1.5 and thickness d=5 mm, is calculated as follows.

$${δs}^{′} = \frac{{n}^{2} - 1}{2 {n}^{3}} β d \qquad [ Math . 1 ]$$

The axial resolution can be estimated according to the Abbe condition, as follows dZ=2λ/(NA²), where λ represents the wavelength of the light beam and NA the numerical aperture in the image space.

In the numerical example hereinabove, this estimation gives an axial resolution dZ of about 2.5 mm for a wavelength λ of 0.5 μm and a spherical aberration δs′ of about 18.5 μm in the focusing plane of the beam. It is observed that the spherical aberration induced by the plate with flat and parallel faces remains limited and causes little deterioration in focusing quality.

The angle of inclination of the glass plate 3 with respect to the optical axis 10 of the microscope is denoted α. By way of example, in FIG. 1, the angle α is represented in XZ-plane. The rotation of the glass plate placed between the optical system 1 and the confocal diaphragm 2 (such as an optical fibre or a confocal hole) enables to accurately adjust the position of the light beam focused by the optical system 1 in the real image plane 12, also called Fourier plane, towards the detection system. The displacement of the focal point as a function of the inclination of the glass plate by an angle α is calculated by the following formula:

$$displ ( α , n ) := d sin ( α ) ( 1 - \frac{cos ( α )}{{n}^{2} - {sin ( α )}^{{2}^{′}}} ) \qquad [ Math . 2 ]$$

where displ represents the displacement of the focused beam in the Fourier plan 12 and n the refractive index of the plate with flat and parallel faces.

This simple design is not commonly used, since in usual practice, light is focused with an image numerical aperture corresponding to that of the optical fibre (NA^{˜}0.22) for the coupling in an optical fibre. Now, in this case, the spherical aberration induced by the plate is unavoidable for the inclined rays and strongly impairs the focusing.

FIG. 2 illustrates an exemplary embodiment, in which the refractive optical component 3 is a glass plate and the confocal diaphragm is consisted by the core of an optical fibre. The glass plate 3 is arranged between the optical system 1, here the tube lens of the microscope, and the plane 12 of the real image formed by the optical system 1 in which is located the optical fibre end. The optical fibre is fixed by a standard connector 6 on a connector support, itself rigidly attached to the microscope frame, for example on a stage 4 that is attached to the microscope body. The glass plate 3 is mounted on an optomechanical support of the line-point-plane type, which allows inclining the plate in two axes transverse to the optical axis 10 of the microscope. For that purpose, adjustment screws 31, 32, are accessible to the user from the outside of the microscope without requiring the microscope to be open. Advantageously, the optical system 1, the glass plate 3 and the optical fibre end remain hidden inside the microscope housing. The optical system 1 and the optical fibre end remain fixed with respect to the microscope body. Only the orientable glass plate enables to adjust the position of the focused beam relative to the optical fibre core. A rotation of the plate by only a few degrees moves the position of the focused light by a few tens or hundreds of micrometres while ensuring stability, high accuracy and ease of adjustment. The inclination by an angle α of ±3 degrees applied to the BK7 glass plate of 5 mm thick enables to laterally move the focal point by ±50 micrometres while maintaining a high quality of focus.

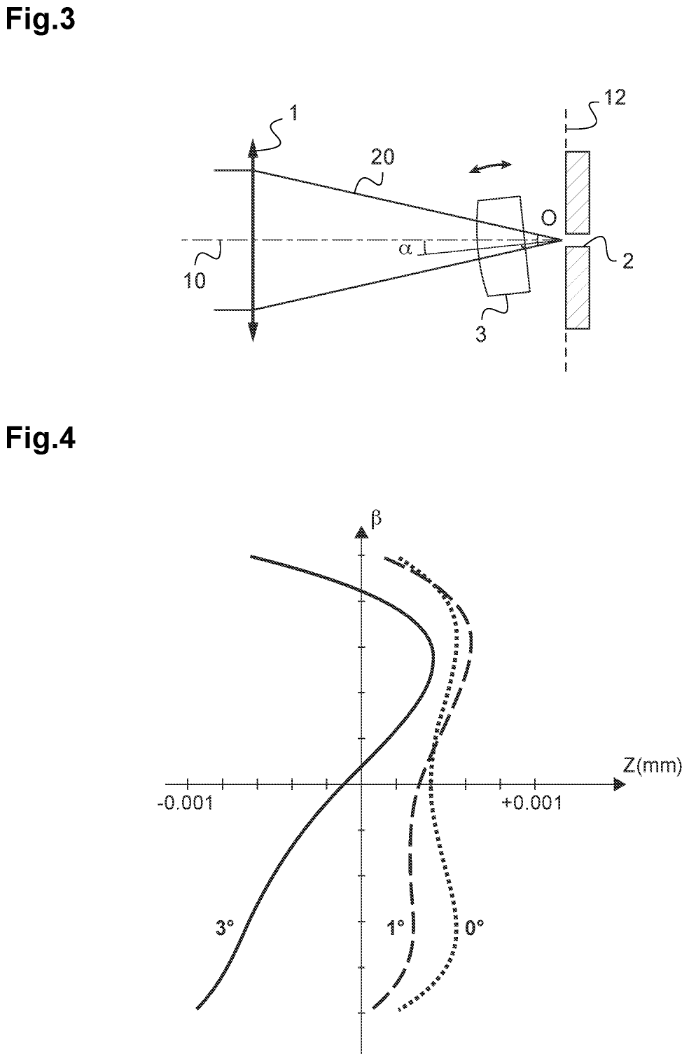

In another embodiment, certain microscope functions require adjustment of the radiation injection to the optical fibre with an image numerical aperture comparable to the numerical aperture of the fibre. In this embodiment, the refractive optical component 3 can no longer be a flat plate as the spherical aberration of the flat plate in the convergent beam reaches unacceptable values comparable to and even higher than the axial resolution of the focusing objective. In this case, instead of the plate with flat and parallel faces, a convergent lens is used. For example, plano-convex lens is used, mounted in such a way that the spherical convex dioptre is positioned on the radiation source side, as illustrated in FIG. 3. This converging lens is rotatably mounted about a centre of rotation O of the optical axis 10, the rotation centre O being located between the lens 3 and the focal plane 12. The rotation of the converging lens enables to adjust the Y and Z position of the focused beam in the focal plane 12 of the optical system 1. Moreover, the spherical aberration caused by the thickness of the lens in the convergent beam can be compensated for the spherical aberration of the convex dioptre. The rotation axis is transverse relative to the optical axis of the microscope at the centre of rotation O, suitably chosen between the spherical surface of the lens and the focal plane (optical fibre end) to minimize the spherical aberration during the lens rotation.

FIG. 4 shows results of analysis of operation of the device described for the embodiment illustrated in FIG. 3, for different values of inclination angle α, of 0 degree (dotted-line curve), 1 degree (dashed-line curve) and 3 degrees (solid-line curve), respectively. The abscissa axis of the graph represents the position of the focal points in millimetres. The ordinate axis represents points corresponding to the numerical aperture of the ray in question, in other words the angle of incidence of the ray on the image plane 12. The points furthest from the horizontal axis of the graph belong to the marginal radii for the image numerical aperture NA=0.23. The displacement of the focal point along the optical axis, caused by the inclination of the lens with respect to the beam rays, is clearly visible on the graph as a function of the aperture of the beam rays for the three inclinations of the lens. The inclined-lens system is no longer a centred system. The radii +β and −β of the meridional plane perpendicular to the axis of rotation of the lens intersect the optical axis at different points. For this analysis, a lens 3 sold by Edmund Optics #45-260 has been used. This is a plano-convex lens (PCX) made of n-BK7 glass, having a central thickness of 3 mm and whose radius R1 of the first surface is 51.68 mm. Calculations are made for a light of wavelength 529 nm, focused by an objective 1 having a numerical aperture NA of 0.22. The positive lens 3 increases the image numerical aperture up to 0.23. The centre of rotation O, placed between the lens 3 and the image plane 12 (where the optical fibre end is located), is 5.1 mm from the top of the convex surface of the lens 3 and 1.5 mm from the image plane 12. A cardan joint or similar mechanism is used, for example, to produce the rotary movement of the lens. The lens inclination of ±3 degrees moves the focal point laterally by ±50 micrometres and causes a spherical aberration limited to ±1 micrometre. However, it is observed that the lens placed in the monochromatic convergent beam has a negligible harmful effect on the focusing quality, as the total value of the aberrations does not exceed approximately one micrometre.

The technical advantage of the fine adjustment according to the proposed invention is obtained thanks to a relatively significant angular movement of a small refractive optical element 3 (plate or lens) for adjusting the position of the focal point of several tens of microns transverse to the optical axis, while remaining focused in a micrometric range along the optical axis. The low mass of the adjustable refractive optical element ensures stability and resistance to vibratory loads of the apparatus.

Of course, various other modifications can be made to the invention within the scope of the appended claims.

1. An optical microscope comprising an optical system (1) and a confocal diaphragm (2), the confocal diaphragm (2) being arranged in a Fourier plane (12) of the microscope, transverse to an optical axis (10) of the microscope, the Fourier plane (12) being optically conjugate with an object plane via the optical system (1), the confocal diaphragm (2) being fixed relative to the microscope body, the microscope being able to collect a light beam (20) from the object plane, the optical system (1) being adapted to focus the light beam (20) in the Fourier plane (12) and to inject at least a portion of the light beam (20) through the confocal diaphragm (2), characterized in that the optical microscope includes a refractive optical component (3) arranged between the optical system (1) and the confocal diaphragm (2), the refractive optical component (3) being rotatably mounted transverse to the optical axis (10) of the microscope, in order to adjust a lateral position of the focused light beam relative to the confocal diaphragm (2).

2. The optical microscope according to claim 1, wherein the confocal diaphragm (2) comprises a confocal hole.

3. The optical microscope according to claim 1, wherein the confocal diaphragm (2) is formed by an end of an optical fibre having a core with micrometric cross-sectional dimensions.

4. The optical microscope according to claim 3, comprising an optical fibre connector, the optical fibre connector being attached rigidly to the microscope body, the optical fibre connector being suitable for receiving the optical fibre end in such a way that the optical fibre end is arranged in a real image plane (12) of the microscope.

5. The optical microscope according to claim 1, wherein the optical system (1) has an image numerical aperture of less than 0.1, and wherein the refractive optical component comprises a transparent plate with flat and parallel faces, the plate being rotatably mounted about at least one axis of rotation transverse to the microscope optical axis.

6. The optical microscope according to claim 5, wherein the plate is a glass plate, the plate having a thickness between 1 mm and 6 mm.

7. The optical microscope according to claim 3, wherein the optical system (1) has an image numerical aperture adapted to that of the optical fibre and wherein the refractive optical component comprises a converging lens rotatably mounted about a centre of rotation on the microscope optical axis between the lens and the focal plane of the optical system (1).

8. The optical microscope according to claim 1, comprising a laser source adapted to generate an excitation laser beam, the confocal diaphragm being arranged between the optical system (1) and a detector adapted to detect a Raman scattering radiation.

9. The optical microscope according to claim 1, comprising an opaque housing (4), the confocal diaphragm (2) and the refractive optical component (3) being arranged inside the housing, the refractive optical component (3) being mounted on a translation and/or rotation stage (30), said stage (30) including optomechanical adjustment means (31, 32), the optomechanical adjustment means (31, 32) being accessible from the outside of the housing (4).

10. The optical microscope according to claim 1, wherein the optical system (1) comprises a microscope objective and/or a tube lens.

11. An optical microscopy method comprising the following steps:
collecting a light beam from an object plane and focusing the collected light beam in a Fourier plane by means of an optical system (1) in a microscope, the Fourier plane (12) being optically conjugate with the object plane, the Fourier plane (12) being transverse to an optical axis (10) of the microscope;
transmitting the collected light beam through a refractive optical component (3) arranged between the optical system (1) and the Fourier plane (12);
focusing the light beam transmitted on a confocal diaphragm arranged in the Fourier plane (12) of the microscope, the confocal diaphragm (2) being fixed with respect to the microscope body;
adjusting the refractive optical component (3) by rotation transverse to the microscope optical axis (10) in order to adjust a lateral position of the focused light beam relative to the confocal diaphragm (2).

12. The optical microscope according to claim 2, wherein the optical system (1) has an image numerical aperture of less than 0.1, and wherein the refractive optical component comprises a transparent plate with flat and parallel faces, the plate being rotatably mounted about at least one axis of rotation transverse to the microscope optical axis.

13. The optical microscope according to claim 4, wherein the optical system (1) has an image numerical aperture of less than 0.1, and wherein the refractive optical component comprises a transparent plate with flat and parallel faces, the plate being rotatably mounted about at least one axis of rotation transverse to the microscope optical axis.

14. The optical microscope according to claim 4, comprising a laser source adapted to generate an excitation laser beam, the confocal diaphragm being arranged between the optical system (1) and a detector adapted to detect a Raman scattering radiation.

15. The optical microscope according to claim 4, comprising an opaque housing (4), the confocal diaphragm (2) and the refractive optical component (3) being arranged inside the housing, the refractive optical component (3) being mounted on a translation and/or rotation stage (30), said stage (30) including optomechanical adjustment means (31, 32), the optomechanical adjustment means (31, 32) being accessible from the outside of the housing (4).

16. The optical microscope according to claim 4, wherein the optical system (1) comprises a microscope objective and/or a tube lens.

17. The optical microscope according to claim 4, comprising a laser source adapted to generate an excitation laser beam, the confocal diaphragm being arranged between the optical system (1) and a detector adapted to detect a Raman scattering radiation.

18. The optical microscope according to claim 8, comprising an opaque housing (4), the confocal diaphragm (2) and the refractive optical component (3) being arranged inside the housing, the refractive optical component (3) being mounted on a translation and/or rotation stage (30), said stage (30) including optomechanical adjustment means (31, 32), the optomechanical adjustment means (31, 32) being accessible from the outside of the housing (4).

19. The optical microscope according to claim 8, wherein the optical system (1) comprises a microscope objective and/or a tube lens.

20. The optical microscope according to claim 9, wherein the optical system (1) comprises a microscope objective and/or a tube lens.
